(19) United States
(12) Patent Application Publication
(10) Pub. No.: US 2019/0077198 A1
(43) Pub. Date: Mar. 14, 2019

(54) PNEUMATIC TIRE

(71) Applicant: TOYO TIRE & RUBBER CO., LTD., Itami-shi (JP)

(72) Inventor: Shuichi Nishikawa, Itami-shi (JP)

(73) Assignee: TOYO TIRE & RUBBER CO., LTD., Itami-shi (JP)

(21) Appl. No.: 16/102,986

(22) Filed: Aug. 14, 2018

(30) Foreign Application Priority Data
Sep. 8, 2017 (JP) 2017-172754

(51) Int. Cl. B60C 11/13; B60C 11/01

(52) U.S. Cl. CPC B60C 11/1307; B60C 11/01; B60C 2011/1338; B60C 2011/133; B60C 2011/013

(57) ABSTRACT

A pneumatic tire includes a sidewall region extending in a tire radial direction, the sidewall region comprises a plurality of protruding regions that protrude in a tire width direction, a dimension in a tire circumferential direction of at least one of the protruding regions is greater than a dimension of a gap in the tire circumferential direction between an adjacent pair of the protruding regions, and the at least one protruding region is provided with a recess at a side face at a side in the tire circumferential direction.

### CROSS REFERENCE TO RELATED APPLICATIONS

This application claims the benefit of priority of Japanese application no. 2017-172754, filed on Sep. 8, 2017, which is incorporated herein by reference.

### BACKGROUND OF THE INVENTION

### Field of the Invention

The present invention relates to a pneumatic tire having a sidewall region that is provided with a plurality of protruding regions which protrude therefrom in the tire width direction.

### Description of the Related Art

Conventionally known as a pneumatic tire is a pneumatic tire having a sidewall region that is provided with a plurality of protruding regions which protrude therefrom in the tire width direction (e.g., Japanese Patent Application Publication Kokai No. 2013-82262). In addition, under bad road conditions such as when the terrain is sandy, rocky, and/or muddy, because traction (nonslipping grabbing force) is produced due to the plurality of protruding regions, it is possible to improve driveability under bad road conditions. However, there is demand for still further improvement in driveability under bad road conditions.

### SUMMARY OF THE INVENTION

The problem is therefore to provide a pneumatic tire permitting improvement in driveability under bad road conditions.

There is provided a pneumatic tire, which includes:

a sidewall region extending in a tire radial direction;

wherein the sidewall region comprises a plurality of protruding regions that protrude in a tire width direction;

wherein a dimension in a tire circumferential direction of at least one of the protruding regions is greater than a dimension of a gap in the tire circumferential direction between an adjacent pair of the protruding regions; and

wherein the at least one protruding region is provided with a recess at a side face at a side in the tire circumferential direction.

Further, the pneumatic tire may have a configuration in which:

wherein the recess extends in the tire radial direction.

Further, the pneumatic tire may have a configuration in which:

wherein the recess is one among a plurality of recesses which are arrayed in the tire radial direction.

Further, the pneumatic tire may have a configuration in which:

wherein the recess is one among a plurality of recesses which are arrayed in the tire width direction.

Further, the pneumatic tire may have a configuration in which:

wherein the recess is separated from an end edge of the side face at the side in the tire circumferential direction.

Further, the pneumatic tire may have a configuration in which:

wherein depth of the recess is less than width of the recess.

Further, the pneumatic tire may have a configuration in which:

wherein a first width dimension at a first location toward an exterior in the tire radial direction of the recess is greater than a second width dimension at a second location toward an interior in the tire radial direction of the recess.

Further, the pneumatic tire may have a configuration in which:

wherein a first depth dimension at a first location toward an exterior in the tire radial direction of the recess is greater than a second depth dimension at a second location toward an interior in the tire radial direction of the recess.

Further, the pneumatic tire may have a configuration in which:

wherein a first depth dimension at a first location toward an interior in the tire width direction of the recess is less than a second depth dimension at a second location toward an exterior in the tire width direction of the recess.

Further, the pneumatic tire may have a configuration in which:

wherein the recess is spot-shaped.

Further, the pneumatic tire may have a configuration in which:

wherein the at least one protruding region is provided with a projecting region that is arrayed with the recess at the side face at the side in the tire circumferential direction.

Further, the pneumatic tire may have a configuration in which:

wherein at least one of the protruding regions is provided with a projecting region that is arranged at an interior of the recess and that protrudes from the recess.

Further, the pneumatic tire may have a configuration in which:

wherein a dimension in the tire radial direction of at least one of the protruding regions is greater than the dimension in the tire circumferential direction of the at least one of the protruding regions.

Further, the pneumatic tire may nave further:

a tread region having a plurality of grooves extending to an exterior edge of the tread region in the tire width direction, and a plurality of blocks partitioned by the plurality of grooves so as to be arrayed in the tire circumferential direction;

wherein the gap is one among a plurality of gaps;

wherein the protruding regions are arrayed in the tire circumferential direction in such fashion as to cause the gaps to be interposed therebetween;

wherein, as viewed from an exterior location in the tire width direction, the protruding regions are aligned with the blocks in the tire radial direction; and

wherein, as viewed from an exterior location in the tire width direction, the gaps are aligned with the grooves in the tire radial direction.

As described above, excellent benefits are provided in that a pneumatic tire is made capable of improvement in driveability under bad road conditions.

### BRIEF DESCRIPTION OF DRAWINGS

FIG. 1 is a view of a section, taken along a tire meridional plane, of the principal components in a pneumatic tire associated with an embodiment;

FIG. 2 is a perspective view of the principal components of a pneumatic tire associated with same embodiment;

FIG. 3 is a side view (drawing as viewed in the tire width direction) of the principal components of a pneumatic tire associated with same embodiment;

FIG. 4 is a view of a section taken along IV-IV in FIG. 3;

FIG. 5 is a view of a section taken along V-V in FIG. 3;

FIG. 6 is a sectional view of the principal components of a pneumatic tire associated with same embodiment, being a view taken along a section in the circumferential direction for purposes of explaining the action thereof;

FIG. 7 is a sectional view of the principal components of a pneumatic tire associated with same embodiment, being a view taken along a section in the circumferential direction for purposes of explaining the action thereof;

FIG. 8 is a side view (drawing as viewed in the tire width direction) of the principal components of a pneumatic tire associated with another embodiment;

FIG. 9 is a side view (drawing as viewed in the tire width direction) of the principal components of a pneumatic tire associated with yet another embodiment;

FIG. 10 is a sectional view, being a view taken along a section in the circumferential direction, of the principal components of a pneumatic tire associated with yet another embodiment;

FIG. 11 is a sectional view, being a view taken along a section in the circumferential direction, of the principal components of a pneumatic tire associated with yet another embodiment;

FIG. 12 is a side view (drawing as viewed in the tire width direction) of the principal components of a pneumatic tire associated with yet another embodiment;

FIG. 13 is a side view (drawing as viewed in the tire width direction) of the principal components of a pneumatic tire associated with yet another embodiment, being a sectional view taken along a section at an intermediate location in the tire width direction of a protruding region; and

FIG. 14 is a sectional view, being a view taken along a section in the circumferential direction, of the principal components of a pneumatic tire associated with yet another embodiment.

### DETAILED DESCRIPTION OF THE INVENTION

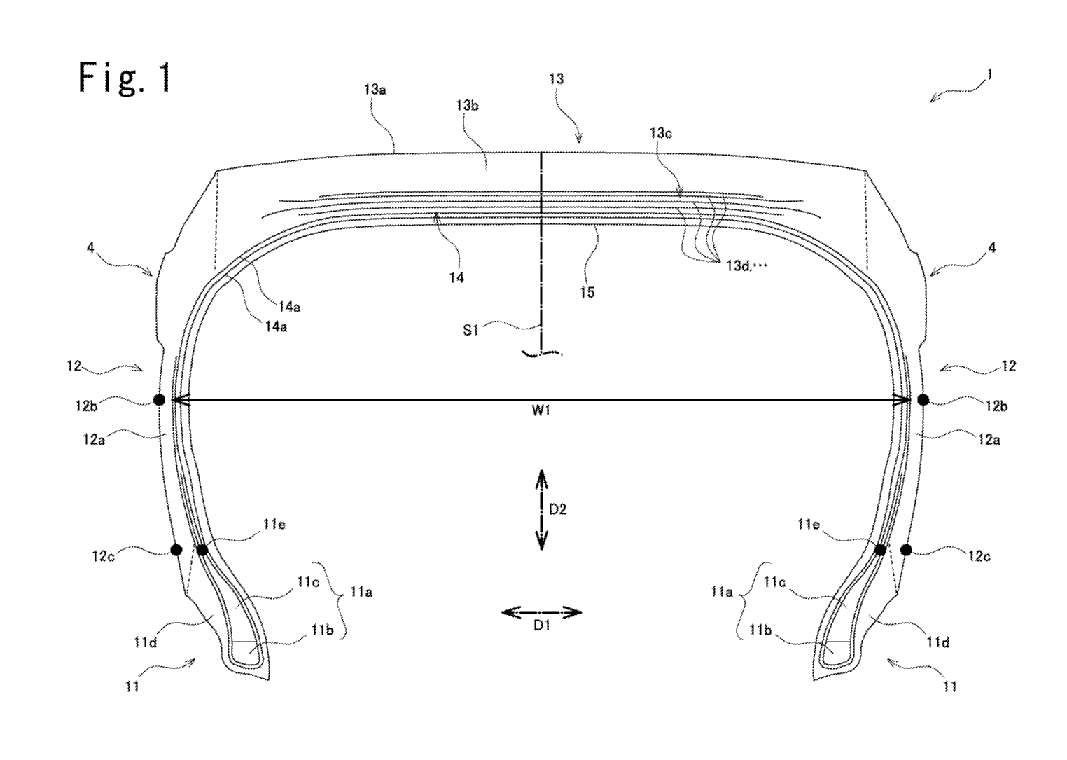

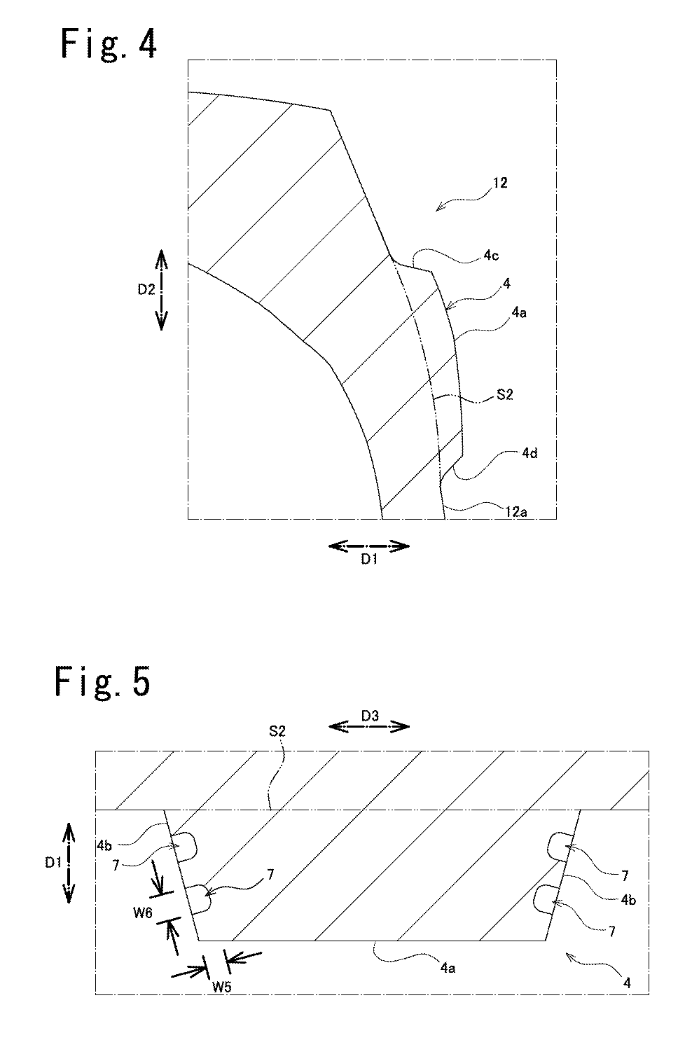

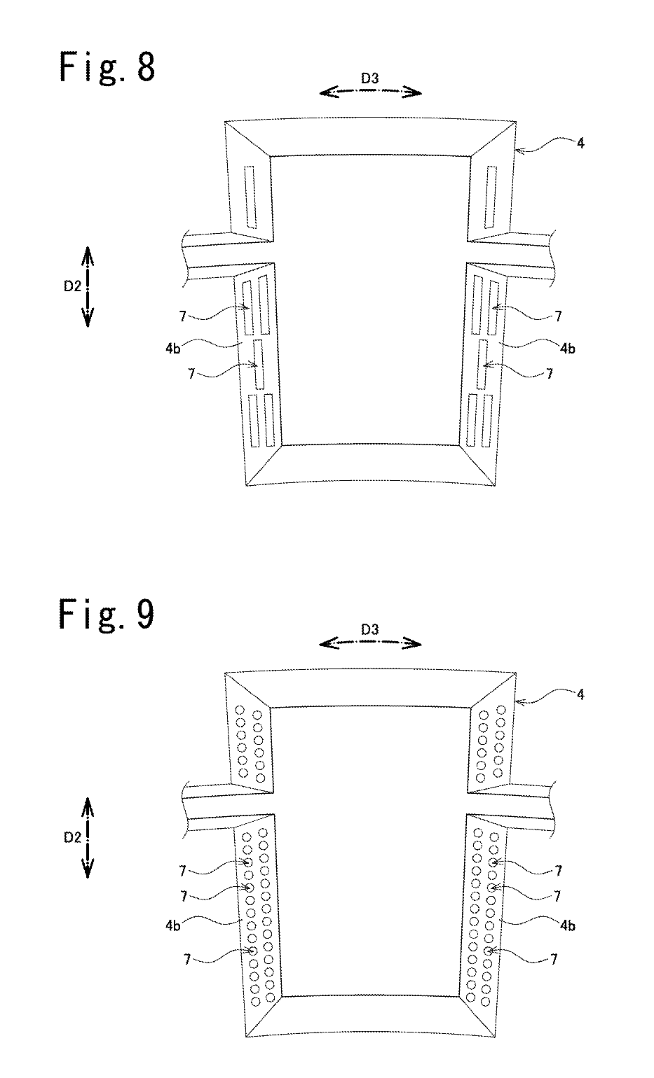

Below, an embodiment of a pneumatic tire is described with reference to FIG. 1 through FIG. 7. At the respective drawings (and the same is true for FIG. 8 through FIG. 14), note that dimensional ratios at the drawings and actual dimensional ratios are not necessarily consistent, and note further that dimensional ratios are not necessarily consistent from drawing to drawing.

As shown in FIG. 1, pneumatic tire (hereinafter sometimes referred to as simply “tire”) 1 associated with the present embodiment is provided with a pair of bead regions 11 having beads 11a. In addition, tire 1 is provided with sidewall regions 12 that extend toward the exterior in the tire radial direction D2 from respective bead regions 11; and tread region 13 having, at the exterior in the tire radial direction D2, tread surface 13a which comes in contact with the ground and which is coupled to the respective exterior edges in the tire radial direction D2 of the pair of sidewall regions 12. Note that tire 1 may be mounted on a rim (not shown).

Furthermore, tire 1 is provided with carcass layer 14 suspended between pair of beads 11a, 11a; and inner-liner 15 that is arranged toward the interior from carcass layer 14 and that faces the interior space of tire 1 which is or will be filled with air. Carcass layer 14 and inner-liner 15 are arranged in parallel fashion with respect to the inner circumferential surface of the tire over a portion thereof that encompasses bead regions 11, sidewall regions 12, and tread region 13.

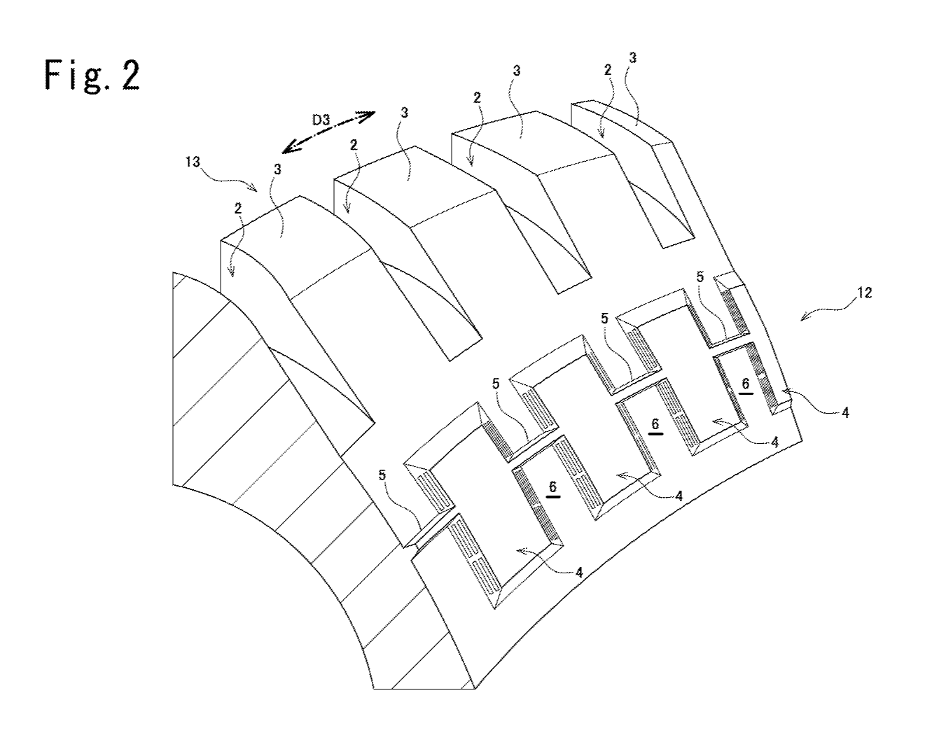

At FIG. 1 (and the same is true for the drawings below), first direction D1 is the tire width direction D1 which is parallel to the rotational axis of the tire, second direction D2 is the tire radial direction D2 which is the direction of the diameter of tire 1, and third direction D3 (see FIG. 2) is the tire circumferential direction D3 which is the direction that is circumferential about the rotational axis of the tire. Furthermore, tire equatorial plane S1 is a plane that is located centrally in the tire width direction D1 and that is perpendicular to the rotational axis of the tire; tire meridional planes are planes that are perpendicular to tire equatorial plane S1 and that contain the rotational axis of the tire.

Bead 11a is provided with bead core 11b which is formed so as to be annular in shape, and bead filler 11c which is arranged toward the exterior in the tire radial direction D2 from bead core 11b. For example, bead core 11b might be formed by laminating rubber-covered bead wire(s) (e.g., metal wire(s)), and bead filler 11c might be formed from hard rubber that has been made to taper as one proceeds toward the exterior in the tire radial direction D2.

Bead region 11 is provided with rim strip rubber 11d which is arranged toward the exterior in the tire width direction D1 from carcass layer 14 and which is intended to constitute the outer surface that will come in contact with the rim. Sidewall region 12 is provided with sidewall rubber 12a which is arranged toward the exterior in the tire width direction D1 from carcass layer 14 and which is intended to constitute the outer surface.

Tread region 13 is provided with tread rubber 13b at which the outer surface constitutes tread surface 13a, and belt region 13c which is arranged between tread rubber 13b and carcass layer 14. Belt region 13c is provided with a plurality (four at FIG. 1) belt plies 13d. For example, belt plies 13d might be provided with a plurality of belt cords (e.g., organic fiber and/or metal) which are arrayed in parallel fashion, and topping rubber with which the belt cords are covered.

Carcass layer 14 is made up of at least one (two at FIG. 1) carcass ply 14a. Carcass ply 14a folds back upon itself and wraps about bead 11a so as to envelop bead 11a. Furthermore, carcass ply 14a is provided with a plurality of ply cords (e.g., organic fiber and/or metal) which are arrayed in direction(s) more or less perpendicular to the tire circumferential direction D3, and topping rubber with which the ply cords are covered.

Inner-liner 15 has superior functionality in terms of its ability to impede passage of gas therethrough so as to permit air pressure to be maintained. At sidewall region 12, note that inner-liner 13 is in intimate contact with the inside circumferential surface of carcass layer 14, there being no other member that intervenes between inner-liner 15 and carcass layer 14.

For example, distance between the inner circumferential surface of the tire (inner circumferential surface of inner-liner 15) and the carcass ply 14a which is arranged nearest to the inner circumferential surface might be 90% to 180% at sidewall region 12 of what it is at tread region 13. More specifically, this distance might be 120% to 160% at sidewall region 12 of what it is at tread region 13.

Sidewall regions 12 are such that provided at the outer surface thereof are locations 12b which are at the same locations in the tire radial direction D2 as the locations at which tire width is a maximum (more specifically, the locations at which distance W1 between respective exterior points in the tire width direction D1 of carcass layer 14 is a maximum). Below, these locations 12b are referred to as tire maximum width locations 12b.

Furthermore, sidewall regions 12 are such that provided at the outer surface thereof are locations 12c which are at the same locations in the tire radial direction D2 as exterior edges 11e of bead filler 11c in the tire radial direction D2. Below, these locations 12c are referred to as bead filler exterior edge locations 12c.

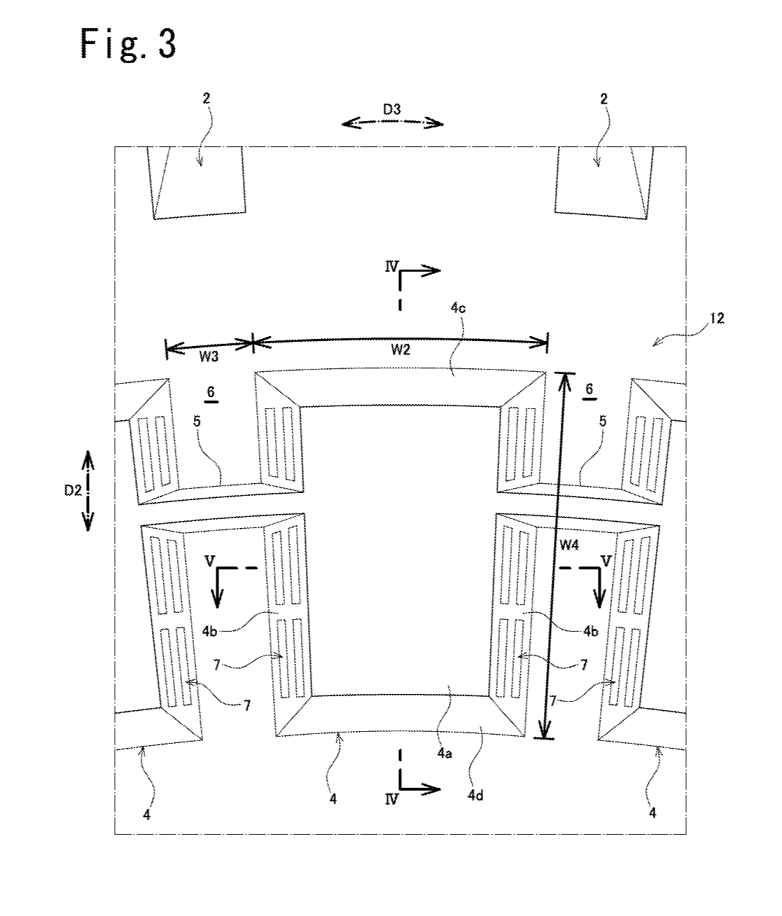

As shown in FIG. 2 and FIG. 3, tread region 13 is provided with a plurality of grooves 2 extending to the exterior edge in the tire width direction D1, and a plurality of blocks 3 partitioned by the plurality of grooves 2 so as to be arrayed in the tire circumferential direction D3. Sidewall region 12 is provided with a plurality of protruding regions 4 which protrude in the tire width direction D1, and a plurality of annular projections 5 which extend in the tire circumferential direction D3. Note that tire 1 may also be constituted such that it is not provided with annular projections 5.

Protruding regions 4 are such that a plurality thereof are arrayed, with gaps 6 therebetween, in the tire circumferential direction D3, and annular projections 5 are arranged in the gaps 6 between protruding regions 4, 4 so as to interconnect protruding regions 4, 4. Note that, as viewed from an exterior location in the tire width direction D1, protruding regions 4 are arranged so as to be aligned with blocks 3 in the tire radial direction D2, and gaps 6 are arranged so as to be aligned with grooves 2 in the tire radial direction D2.

Furthermore, protruding regions 4 and annular projections 5 are arranged at least at the exterior in the tire radial direction D2 of sidewall regions 12. In accordance with the present embodiment, protruding regions 4 and annular projections 5 are arranged toward the exterior in the tire radial direction D2 from bead filler exterior edge locations 12c (see FIG. 1) of sidewall regions 12. More specifically, protruding regions 4 are arranged toward the exterior in the tire radial direction D2 from tire maximum width locations 12b (see FIG. 1) of sidewall regions 12.

As a result, under muddy and/or sandy conditions, when the weight of the vehicle causes tire 1 to sink such that it is buried under mud and/or sand, protruding regions 4 and annular projections 5 are able to come in contact with the ground; and under rocky conditions, protruding regions 4 and annular projections 5 are able to come in contact with irregular surfaces of rocks. That is, protruding regions 4 and annular projections 5 come in contact with the ground under bad road conditions such as when the terrain is muddy, sandy, and/or rocky. Note that protruding regions 4 and annular projections 5 do not come in contact with the ground during normal travel on a flat road.

Thus, existence of irregular shapes formed by protruding regions 4 and annular projections 5 permits formation of surface and edge components. In addition, at locations where contact with the ground takes place at mud, sand, or rock, formation of irregular shapes permits increase in the area over which contact with the ground occurs at mud, sand, or rock; furthermore, surfaces and edges resulting from such irregular shapes facilitate contact with the ground at mud, sand, or rock at a variety of locations, in this way, formation of irregular shapes at locations where contact with the ground takes place at mud, sand, or rock improves traction capability.

As shown in FIG. 3 through FIG. 3, protruding regions 4 and annular projections 5 respectively protrude outwardly in the tire width direction D1 from the profile surface (reference surface) S2. Moreover, the amount by which protruding region 4 protrudes from profile surface S2 might, for example, be not less than 3 mm, it being preferred that this be not less than 8 mm. Furthermore, the amount by which protruding region 4 protrudes from profile surface S2 might be the same as the amount by which annular projection 5 protrudes from profile surface S2, or might be greater than the amount by which this protrudes therefrom.

Dimension W2 in the tire circumferential direction D3 of protruding region 4 is greater than dimension W3 of gap 6 in the tire circumferential direction D3 between protruding regions 4, 4. Furthermore, dimension W4 in the tire radial direction D2 of protruding region 4 is greater than dimension W2 in the tire circumferential direction D3 of protruding region 4.

Protruding region 4 is provided with apex 4a which is formed so as to be planar; pair of circumferentially lateral faces 4b, 4b which are arranged at the sides in the tire circumferential direction D3; radially outer face 4c which is arranged toward the exterior in the tire radial direction D2; and radially inner face 4d which is arranged toward the interior in the tire radial direction D2. In addition, protruding region 4 is provided at respective circumferentially lateral faces 4b with a plurality of recesses 7.

Recess 7 extends in the tire radial direction D2, being formed in the shape of a groove. In addition, recess 7 is separated by some distance(s) from the end edge(s) of circumferentially lateral face 4b. This makes it possible to suppress reduction in rigidity at edges of recess 7 that might otherwise occur.

Moreover, depth dimension W5 of recess 7 is less than width dimension W6 of recess 7. As a result, because this may, for example, make it possible to suppress reduction in rigidity at protruding region 4, it may be possible to increase traction produced at protruding region 4. Furthermore, because this may, for example, make it possible to suppress reduction in rigidity at edges of recess 7, it may be possible to increase traction produced at edges of recess 7.

Recesses 7 are such that a plurality thereof are provided which are arrayed in the tire radial direction D2 and which are arrayed in the tire width direction D1. In accordance with the present embodiment, recesses 7 are arrayed in linear groups of three in the tire radial direction D2, and are arrayed in groups of two in the tire width direction D1. Moreover, depth dimensions W5 of the respective recesses 7 are the same, and width dimensions W6 of the respective recesses 7 are the same.

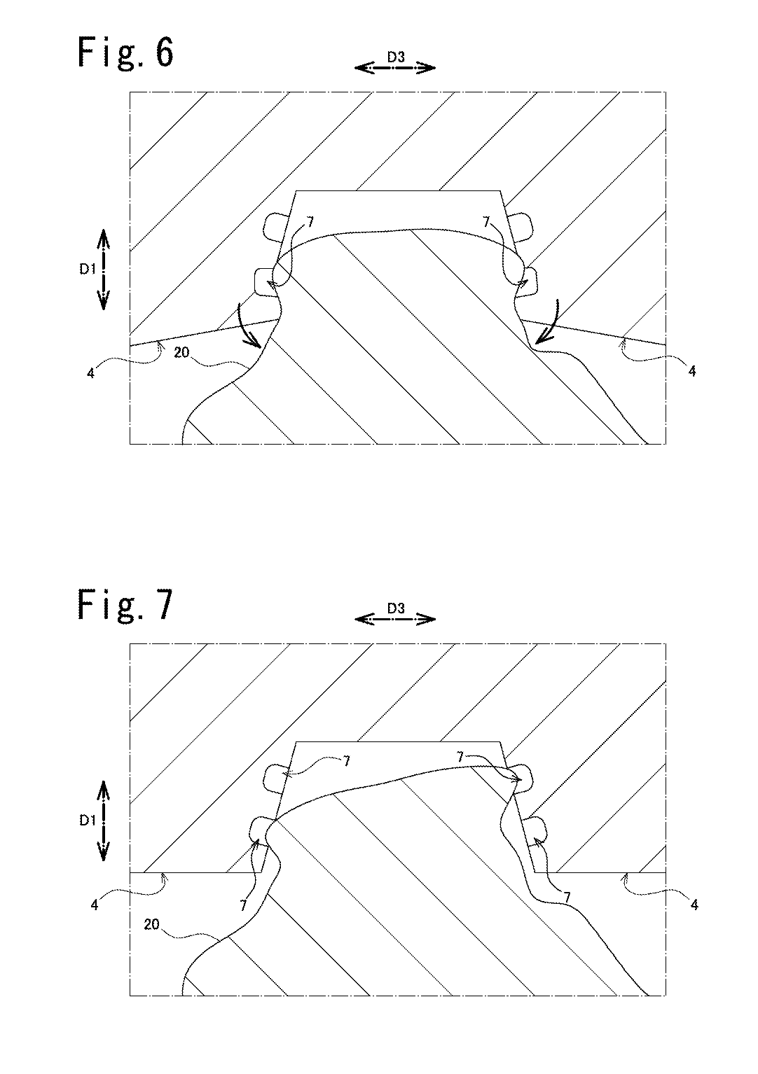

Constitution of tire 1 associated with the present embodiment is as described above; exemplary action of tire 1 associated with the present embodiment is described below with reference to FIG. 6 and FIG. 7.

First, recesses 7 extend in the tire radial direction D2, a plurality of recesses 7 being arrayed in the tire radial direction D2. As a result, as shown in FIG. 6, because protruding region 4 is deformed (in the directions of the arrows at FIG. 6) so to pivot about recess 7, depressing recess 7, rock 20 located between protruding regions 4, 4 is grabbed by pair of protruding regions 4, 4. Accordingly, because traction produced by protruding region 4 with respect to rock 20 is increased, improvement in driveability over rocky terrain is made possible.

Furthermore, because recesses 7 are provided at circumferentially lateral faces 4b, the number of edge components at protruding regions 4 is increased. Moreover, as shown in FIG. 7, because a plurality of recesses 7 are arrayed in the tire width direction D1, production of traction by recess 7 in correspondence to the shape of the rock 20 located between protruding regions 4, 4 is facilitated.

At FIG. 7, protruding region 4 at the left side grabs rock 20 at a recess 7 which is toward the exterior in the tire width direction D1, and protruding region 4 at the right side grabs rock 20 at a recess 7 which is toward the interior in the tire width direction D1. Thus, because it is possible to increase the amount of traction produced by protruding regions 4 with respect to rocks 20 having a wide variety of shapes, effective improvement in driveability over rocky terrain is made possible.

Note that the action which may be provided by tire 1 is not limited to the action associated with FIG. 6 and FIG. 7. For example, because recesses 7 are provided at circumferentially lateral faces 4b, the number of edge components of protruding regions 4 is increased. This increases traction produced by protruding regions 4. Furthermore, because recess(es) 7 are separated by some distance(s) from end edge(s) of circumferentially lateral face(s) 4b, it is possible to suppress reduction in rigidity at edge(s) of recess(es) 7 that might otherwise occur. This increases traction produced by edge(s) at recess(es) 7. If is thus possible to improve driveability not only over rocky terrain but also over muddy and/or sandy terrain.

As described above, the pneumatic tire 1 of the embodiment include a sidewall region 12 extending in a fire radial direction D2, the sidewall region 12 comprises a plurality of protruding regions 4 that protrude in a tire width direction D1, a dimension W2 in a tire circumferential direction D3 of at least one of the protruding regions 4 is greater than a dimension W3 of a gap 6 in the tire circumferential direction D3 between an adjacent pair of the protruding regions 4, 4, and the at least one protruding region 4 is provided with a recess 7 at a side face 4b at a side in the tire circumferential direction D3.

In accordance with such constitution, because dimension W2 in the tire circumferential direction D3 of protruding region 4 is greater than dimension W3 of gap 6 in the tire circumferential direction D3 between protruding regions 4, 4, rigidity of protruding region 4 is increased. This increases traction produced by protruding regions 4. Moreover, because recesses 7 are provided at side faces 4b at the sides in the tire circumferential direction D3 of protruding region 4, and because the number of edge components at protruding region 4 is increased, traction produced at protruding region 4 is increased. Accordingly, improvement in driveability under bad road conditions is made possible.

In the pneumatic tire 1 of the embodiment, the recess 7 extends in the tire radial direction D2.

In accordance with such constitution, because recess 7 extends in the tire radial direction D2, protruding region 4 is deformed in such fashion as to pivot about recess 7. As a result, because protruding region 4 is deformed in such fashion as to grab rock 20 located between protruding regions 4, 4, traction produced by protruding region 4 with respect to rock 20 is increased. Accordingly, effective improvement in driveability over rocky terrain is made possible.

In the pneumatic tire 1 of the embodiment, the recess 7 is one among a plurality of recesses 7 which are arrayed in the tire radial direction D2.

In accordance with such constitution, because a plurality of recesses 7 are provided which are arrayed in the tire radial direction D2, protruding region 4 is deformed in such fashion as to pivot about recess 7. As a result, because protruding region 4 is deformed in such fashion as to grab rock 20 located between protruding regions 4, 4, traction produced by protruding region 4 with respect to rock 20 is increased. Accordingly, effective improvement in driveability over rocky terrain is made possible.

In the pneumatic tire 1 of the embodiment, the recess 7 is one among a plurality of recesses 7 which are arrayed in the tire width direction D1.

In accordance with such constitution, because a plurality of recesses 7 are arrayed in the tire width direction D1, production of traction by recesses 7 in correspondence to the wide variety of shapes of rocks 20 that may be located between protruding regions 4, 4 is facilitated. Because this makes it possible to increase the amount of traction produced by protruding regions 4 with respect to rocks 20 having a wide variety of shapes, effective improvement in driveability over rocky terrain is made possible.

In the pneumatic tire 1 of the embodiment, the recess 7 is separated from an end edge of the side face 4b at the side in the tire circumferential direction D3.

In accordance with such constitution, because recess(es) 7 are separated by some distance(s) from end edge(s) of side face(s) 4b at the sides in the tire circumferential direction D3, it is possible to suppress reduction in rigidity at edge(s) of recess(es) 7. As a result, because increased traction is produced at edge(s) of recess(es) 7, effective improvement in driveability under bad road conditions is made possible.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that recesses 7 are arrayed in the tire width direction D1 so as to encompass the full length in the tire radial direction D2 of circumferentially lateral face 4b. However, pneumatic tire 1 is not limited to such constitution. For example, as shown in FIG. 8, it is also possible to adopt a constitution in which recesses 7 are arrayed in the tire width direction D1 in such fashion as to encompass a portion of the length in the tire radial direction D2 of circumferentially lateral face 4b. In addition, recesses 7 associated with FIG. 8 are arranged so as to not be aligned in the tire radial direction D2 with adjacent recess(es) 7 in the tire radial direction D2.

(2) Furthermore, the constitution of pneumatic tire 1 associated with the foregoing embodiment is such that recesses 7 extend in the tire radial direction D2. However, pneumatic tire 1 is not limited to such constitution. It is also possible, for example, to adopt a constitution in which recesses 7 extend in the tire width direction D1, and it is also possible, as shown in FIG. 9, to adopt a constitution in which these are spot-shaped (e.g., of such shape that the ratio of the maximum width dimension to the minimum width dimension thereof is not greater than 200%).

In accordance with such constitution, it will be possible to increase the number of edge components at circumferentially lateral face(s) 4b, and it will be possible to increase rigidity at edge(s) of recess(es) 7. Recesses 7 associated with FIG. 9 are formed so as to be circular in shape and such that a plurality thereof are arrayed in the tire radial direction D2. Note that spot-shaped recesses 7 are not limited to such constitution, it being possible, for example, to adopt a constitution in which these are polygonal (e.g., triangular, in the shape of an equilateral triangle, rectangular, in the shape of a square, pentagonal, in the shape of a regular pentagon, etc.) and/or elliptical.

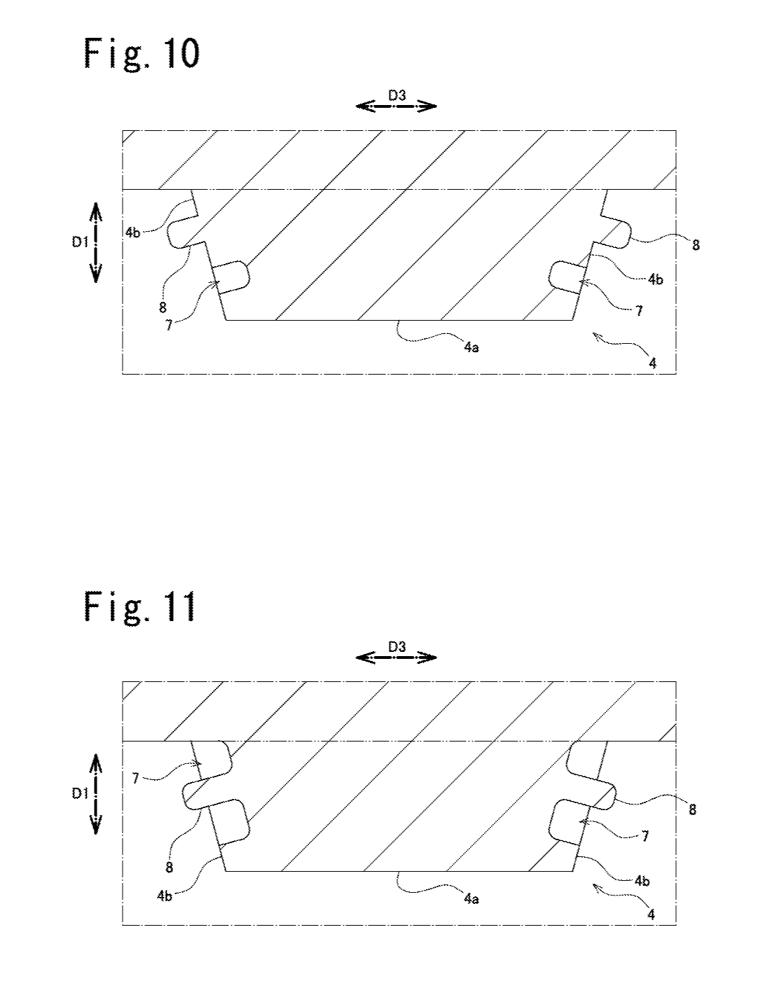

(3) Furthermore, the constitution of pneumatic tire 1 associated with the foregoing embodiment is such that protruding region 4 is such that only recess(es) 7 are provided on circumferentially lateral face(s) 4b. However, pneumatic tire 1 is not limited to such constitution. For example, as shown in FIG. 10, it is also possible to adopt a constitution in which protruding region 4 is such that not only recess(es) 7 but also projecting region(s) 8 that are arrayed with recess(es) 7 are provided on circumferentially lateral face(s) 4b. Furthermore, for example as shown in FIG. 11, it is also possible to adopt a constitution in which protruding region 4 is such that not only recess(es) 7 but also projecting region(s) 8 that are arranged at the interior(s) of recess(es) 7 and that protrude from recess(es) 7 are provided on circumferentially lateral face(s) 4b.

(4) Furthermore, the constitution of pneumatic tire 1 associated with the foregoing embodiment is such that protruding region 4 is such that recesses 7 are respectively provided at both circumferentially lateral faces 4b, 4b. However, pneumatic tire 1 is not limited to such constitution. For example, it is also possible to adopt a constitution in which protruding region 4 is such that recess(es) 7 are provided at only one circumferentially lateral face 4b. Moreover, it is preferred that the constitution be such that recesses 7 are respectively provided at adjacent circumferentially lateral faces 4b, 4b of adjacent protruding regions 4, 4 so as to cause rock 20 located between protruding regions 4, 4 to be mutually grabbed by adjacent protruding regions 4, 4.

(5) Furthermore, the constitution of pneumatic tire 1 associated with the foregoing embodiment is such that a plurality of recesses 7 are arrayed in the tire radial direction D2 and is such that a plurality thereof are arrayed in the tire width direction D1. However, pneumatic tire 1 is not limited to such constitution. For example, it is also possible to adopt a constitution in which recesses 7 are arranged in groups of one in the tire radial direction D2, and it is also possible to adopt a constitution in which these are arranged in groups of one in the tire width direction D1.

(6) Furthermore, the constitution of pneumatic tire 1 associated with the foregoing embodiment is such that recess(es) 7 are separated by some distance(s) from end edge(s) of circumferentially lateral face(s) 4b. However, pneumatic tire 1 is not limited to such constitution. For example, it is also possible to adopt a constitution in which recess(es) 7 are connected to end edge(s) of circumferentially lateral facets) 4b.

(7) Furthermore, the constitution of pneumatic tire 1 associated with the foregoing embodiment is such that dimension W4 in the tire radial direction D2 of protruding region 4 is greater than dimension W2 in the tire circumferential direction D3 of protruding region 4. However, pneumatic tire 1 is not limited to such constitution. For example, it is also possible to adopt a constitution in which dimension W4 in the tire radial direction D2 of protruding region 4 is less than dimension W2 in the tire circumferential direction D3 of protruding region 4, and it is also possible to adopt a constitution in which it is the same as dimension W2 in the tire circumferential direction D3 of protruding region 4.

(8) Furthermore, the constitution of pneumatic tire 1 associated with the foregoing embodiment is such that depth dimension W5 of recess 7 is less than width dimension W6 of recess 7. However, pneumatic tire 1 is not limited to such constitution. For example, it is also possible to adopt a constitution in which depth dimension W5 of recess 7 is greater than width dimension W6 of recess 7. In accordance with such constitution, deformation of protruding region 4 in such fashion as to pivot about recess 7 is facilitated, and the area of recess 7 available for grabbing rocks is increased, for example. Note that it is also possible to adopt a constitution in which depth dimension W5 of recess 7 is the same as width dimension W6 of recess 7.

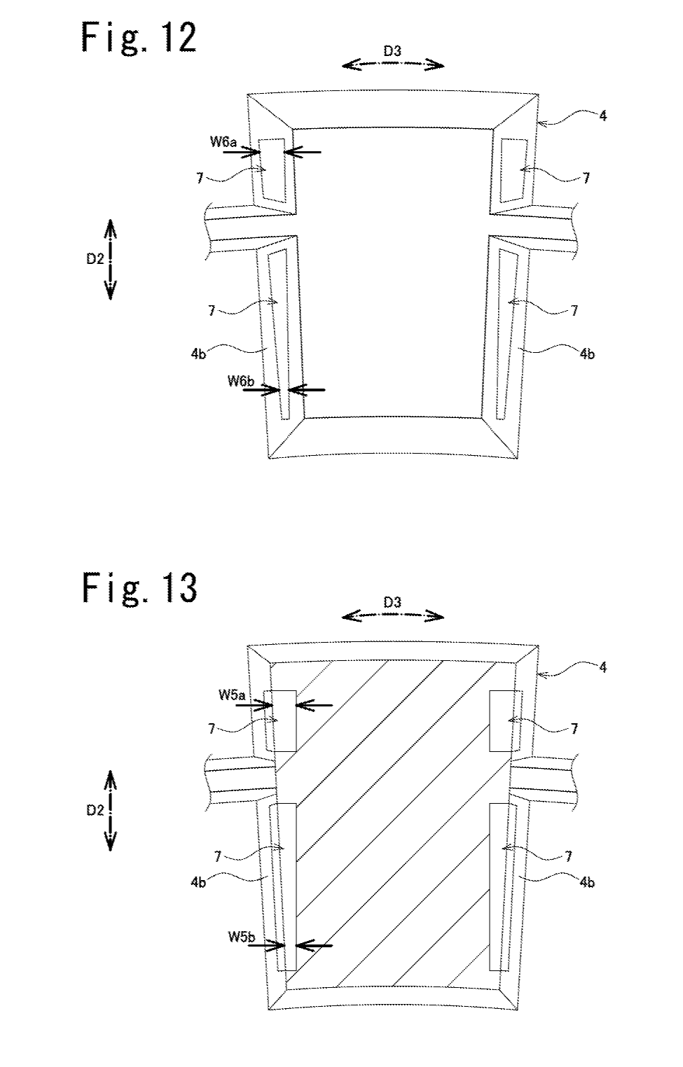

(9) Furthermore, the constitution of pneumatic tire 1 associated with the foregoing embodiment is such that respective width dimensions we at recess(es) 7 are the same. However, pneumatic tire 1 is not limited to such constitution. For example, as shown in FIG. 12, it is also possible to adopt a constitution in which respective width dimensions W6a, W6b of recess(es) 7 are different.

At recess 7 associated with FIG. 12, width dimension W6a of recess 7 toward the exterior in the tire radial direction D2 is greater than width dimension W6b of recess 7 toward the interior. More specifically, width dimensions W6a, W6b of recess 7 associated with FIG. 12 gradually increase as one proceeds toward the exterior in the tire radial direction D2.

Now, because of the existence of protruding region 4, any nonuniformity with regard to weight balance of tire 1 will cause the vehicle to vibrate during driving. Moreover, the more toward the exterior and farther in the tire radial direction D2 from the rotational axis of the tire the greater will be the vibration of the vehicle due to nonuniformity with regard to weight balance of tire 1.

To address this, at recess 7 associated with FIG. 12, volume of the recess is made to increase as one proceeds toward the exterior in the tire radial direction D2, which is to say as one goes farther away from the rotational axis of the tire. Because this makes it possible to suppress nonuniformity with regard to weight balance of tire 1 at the exterior in the tire radial direction D2, it will, for example, make it possible to suppress vibration of the vehicle during driving due to presence of protruding region 4.

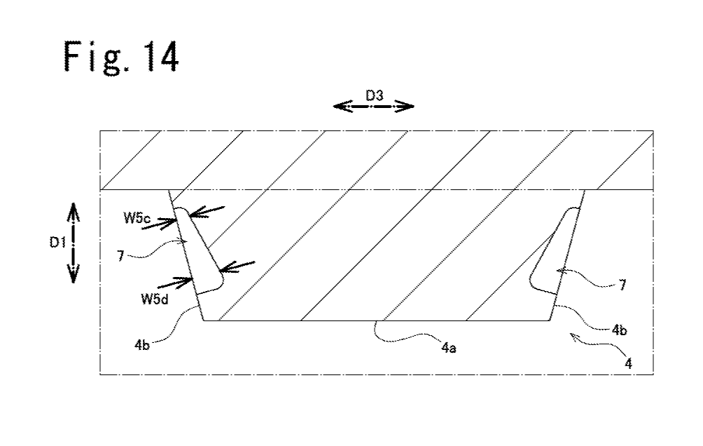

(10) Furthermore, the constitution of pneumatic tire 1 associated with the foregoing embodiment is such that respective depth dimensions W5 at recess(es) 7 are the same. However, pneumatic tire 1 is not limited to such constitution. For example, as shown in FIG. 13 and FIG. 14, it is also possible to adopt a constitution in which respective depth dimensions W5a through W5d of recess(es) 7 are different.

(10-1) At recess(es) 7 associated with FIG. 13, depth dimension W5a of recess(es) 7 toward the exterior in the tire radial direction D2 is greater than depth dimension W5b of recess(es) 7 toward the interior. Mere specifically, depth dimensions W5a, W5b of recess(es) 7 associated with FIG. 13 gradually increase as one proceeds toward the exterior in the tire radial direction D2.

Now, because of the existence of protruding region 4, any nonuniformity with regard to weight balance of tire 1 will cause the vehicle to vibrate during driving. Moreover, the more toward the exterior and farther in the tire radial direction D2 from the rotational axis of the tire the greater will be the vibration of the vehicle due to nonuniformity with regard to weight balance of tire 1.

To address this, at recess(es) 7 associated with FIG. 13, volume of the recess is made to increase as one proceeds toward the exterior in the tire radial direction D2, which is to say as one goes farther away from the rotational axis of the tire. Because this makes it possible to suppress nonuniformity with regard to weight balance of tire 1 at the exterior in the tire radial direction D2, it will, for example, make it possible to suppress vibration of the vehicle during driving due to presence of protruding region 4.

(10-2) At recess 7 associated with FIG. 14, depth dimension W5c of recess 7 toward the interior in the tire width direction D1 is less than depth dimension W5d of recess 7 toward the exterior. More specifically, depth dimension(s) W5c, W5d of recess 7 associated with FIG. 14 gradually decrease as one proceeds toward the interior in the tire width direction D1.

In accordance with such constitution, because depth dimension W5c of recess 7 at the interior in the tire width direction D1 is small, expulsion of mud that has entered the interior of recess 7 to the exterior of recess 7 is facilitated. Moreover, despite the fact that depth dimension W5c of recess 7 at the interior in the tire width direction D1 is small, because rigidity of protruding region 4 increases as one proceeds toward the interior in the tire width direction D1, benefit due to edge(s) at recess(es) 7 can be adequately manifested at the interior in the tire width direction D1.

(11) Furthermore, the constitution of pneumatic tire 1 associated with the foregoing embodiment is such that protruding region 4 is such that recess(es) 7 are provided only on circumferentially lateral face(s) 4b. However, pneumatic tire 1 is not limited to such constitution. For example, it is also possible to adopt a constitution in which protruding region 4 is such that, in addition to being provided on circumferentially lateral face 4b, recess(es) 7 are also provided on at least one of apex 4a, radially outer face 4c, and radially inner face 4d.

(12) Furthermore, the constitution of pneumatic tire 1 associated with the foregoing embodiment is such that recess 7 is provided at all protruding regions 4. However, pneumatic tire 1 is not limited to such constitution. For example, it is sufficient that recess 7 be provided at at least one of the plurality of protruding regions 4. Moreover, a constitution in which recess 7 is provided at at least one-quarter of the plurality of protruding regions 4 is preferred, a constitution in which it is provided at at least one-third thereof is more preferred, and a constitution in which it is provided at at least one-half thereof is still more preferred.

(13) Furthermore, the constitution of pneumatic tire 1 associated with the foregoing embodiment is such that all of the protruding regions 4 are of the same shape, and all of the recesses 7 are of the same shape. However, pneumatic tire 1 is not limited to such constitution. For example, it is also possible to adopt a constitution in which protruding regions 4 are provided with a plurality of different shapes, these respectively being arranged in order in the tire circumferential direction D3. Furthermore, it is also possible, for example, to adopt a constitution in which recesses 7 are provided with a plurality of different shapes, these being arranged in order in the tire circumferential direction D3 at the respective protruding regions 4.

(14) Furthermore, in the context of a constitution in which protruding regions 4 are provided at both of the sidewall regions 12, the constitution of pneumatic tire 1 may be such that recess(es) 7 are provided only at protruding region(s) 4 at one of the sidewall regions 12, or the constitution may be such that these are provided at protruding region(3) 4 at both of the sidewall regions 12. For example, it is also possible to adopt a constitution in which recess(es) 7 are at least provided at protruding region(s) 4 at the sidewall region 12 which of the two sidewall regions 12 is the sidewall region 12 that is arranged so as to be toward the exterior when mounted on the vehicle.

What is claimed is:

1. A pneumatic tire comprising a sidewall region extending in a tire radial direction;
wherein the sidewall region comprises a plurality of protruding regions that protrude in a tire width direction;
wherein a dimension in a tire circumferential direction of at least one of the protruding regions is greater than a dimension of a gap in the tire circumferential direction between an adjacent pair of the protruding regions; and
wherein the at least one protruding region is provided with a recess at a side face at a side in the tire circumferential direction.

2. The pneumatic tire according to claim 1 wherein the recess extends in the tire radial direction.

3. The pneumatic tire according to claim 1 wherein the recess is one among a plurality of recesses which are arrayed in the tire radial direction.

4. The pneumatic tire according to claim 1 wherein the recess is one among a plurality of recesses which are arrayed in the tire width direction.

5. The pneumatic tire according to claim 1 wherein the recess is separated from an end edge of the side face at the side in the tire circumferential direction.

6. The pneumatic tire according to claim 2 wherein depth of the recess is less than width of the recess.

7. The pneumatic tire according to claim 2 wherein a first width dimension at a first location toward an exterior in the tire radial direction of the recess is greater than a second width dimension at a second location toward an interior in the tire radial direction of the recess.

8. The pneumatic tire according to claim 2 wherein a first depth dimension at a first location toward an exterior in the tire radial direction of the recess is greater than a second depth dimension at a second location toward an interior in the tire radial direction of the recess.

9. The pneumatic tire according to claim 2 wherein a first depth dimension at a first location toward an interior in the tire width direction of the recess is less than a second depth dimension at a second location toward an exterior in the tire width direction of the recess.

10. The pneumatic tire according to claim 1 wherein the recess is spot-shaped.

11. The pneumatic tire according to claim 1 wherein the at least one protruding region is provided with a projecting region that is arrayed with the recess at the side face at the side in the tire circumferential direction.

12. The pneumatic tire according to claim 1 wherein at least one of the protruding regions is provided with a projecting region that is arranged at an interior of the recess and that protrudes from the recess.

13. The pneumatic tire according to claim 1 wherein a dimension in the tire radial direction of at least one of the protruding regions is greater than the dimension in the tire circumferential direction of the at least one of the protruding regions.

14. The pneumatic tire according to claim 1 farther comprising a tread region having a plurality of grooves extending to an exterior edge of the tread region in the tire width direction, and a plurality of blocks partitioned by the plurality of grooves so as to be arrayed in the tire circumferential direction;
wherein the gap is one among a plurality of gaps;
wherein the protruding regions are arrayed in the tire circumferential direction in such fashion as to cause the gaps to be interposed therebetween;
wherein, as viewed from an exterior location in the tire width direction, the protruding regions are aligned with the blocks in the tire radial direction; and
wherein, as viewed from an exterior location in the tire width direction, the gaps are aligned with the grooves in the tire radial direction.
